(19) United States
(12) Patent Application Publication
(10) Pub. No.: US 2013/0201737 A1
(43) Pub. Date: Aug. 8, 2013

(54) OFF-GRID MASTER-SLAVE SOLAR INVERTER SYSTEM AND METHOD THEREOF

(71) Applicant: DARFON ELECTRONICS CORP., Taoyuan (TW)

(72) Inventors: Chang-Chia Chiang, Taoyuan (TW); Li Hsiang, Taoyuan (TW); Hsiao-Chih Ku, Taoyuan (TW)

(73) Assignee: DARFON ELECTRONICS CORP., Taoyuan (TW)

(21) Appl. No.: 13/748,615

(22) Filed: Jan. 24, 2013

(30) Foreign Application Priority Data
Feb. 8, 2012 (TW) 101104012

(51) Int. Cl. H02M 7/42

(52) U.S. Cl. CPC H02M 7/42
USPC 363/72

(57) ABSTRACT

A control method of an off-grid master-slave solar inverter system includes powering on the off-grid master-slave solar inverter system; a controller controlling a first inverter and a second inverter to prepare to output pulses corresponding to a first series number and pulses corresponding to a second series number, respectively; only the first inverter outputting a pulse corresponding to a first number of the first series number; and the controller controlling the first inverter to output a first alternating current voltage and the second inverter to output a second alternating current voltage with a frequency of the first alternating current voltage after a first predetermined time.

### BACKGROUND OF THE INVENTION

1. Field of the Invention

The present invention relates to an off-grid master-slave solar inverter system and a control method thereof, and particularly to an off-grid master-slave solar inverter system and a control method thereof that can utilize a controller to control a first inverter to output pulses corresponding a first series number and a second inverter to output pulses corresponding a second series number respectively to determine which inverter is a master inverter.

2. Description of the Prior Art

In the prior art, an off-grid master-slave solar inverter system fixedly sets an inverter included in the off-grid master-slave solar inverter system to be a master inverter, where a frequency of an alternating current (AC) voltage outputted by the master inverter is a reference frequency. Therefore, other inverters included in the off-grid master-slave solar inverter system output AC voltages with the frequency of the AC voltage outputted by the master inverter according to the frequency of the AC voltage outputted by the master inverter. Thus, each inverter included in the off-grid master-slave solar inverter system can output an AC voltage with the same frequency. However, each inverter included in the off-grid master-slave solar inverter system can not output an AC voltage with the same frequency when the master inverter can not function well (that is, the master inverter can not provide the reference frequency), resulting in the off-grid master-slave solar inverter system malfunctioning.

In addition, the off-grid master-slave solar inverter system can also utilize a controller to communicate with each inverter through a communication port of each inverter to determine which inverter included in the off-grid master-slave solar inverter system is a master inverter. However, the method is more complicated and still face malfunction of the master inverter.

### SUMMARY OF THE INVENTION

An embodiment provides a control method of an off-grid master-slave solar inverter system, where the off-grid master-slave solar inverter system includes a first inverter, a second inverter, and a controller. The control method includes powering on the off-grid master-slave solar inverter system; the controller controlling the first inverter and the second inverter to prepare to output pulses corresponding to a first series number and pulses corresponding to a second series number, respectively; only the first inverter outputting a pulse corresponding to a first number of the first series number; and the controller controlling the first inverter to output a first AC voltage and the second inverter to output a second AC voltage with a frequency of the first AC voltage after a first predetermined time.

Another embodiment provides an off-grid master-slave solar inverter system. The off-grid master-slave solar inverter system includes a first inverter, a second inverter, and a controller. The first inverter has a first input terminal for coupling to a solar panel, and a first output terminal for coupling to a load, where the first inverter is used for outputting pulses corresponding to a first series number and converting a direct current (DC) voltage of the solar panel into a first AC voltage; the second inverter has a second input terminal for coupling to the solar panel, and a second output terminal for coupling to the load, where the second inverter is used for outputting pulses corresponding to a second series number and converting the DC voltage of the solar panel into a second AC voltage; and the controller is coupled to the first inverter and the second inverter for controlling the first inverter and the second inverter to output the pulses corresponding to the first series number and the pulses corresponding to the second series number, respectively, and controlling the first inverter and the second inverter to output the first AC voltage and the second AC voltage, respectively.

The present invention provides an off-grid master-slave solar inverter system and a control method thereof. The off-grid master-slave solar inverter system and the control method utilize a controller to control a first inverter and a second inverter to output pulses corresponding to a first series number and pulses corresponding to a second series number, respectively. Then, the controller can determine which inverter is a master inverter by a condition of the first inverter and the second inverter outputting the pulses corresponding to the first series number and the pulses corresponding to the second series number, respectively. Therefore, compared to the prior art, the control method provided by the present invention is simpler. In addition, when the master inverter fails, the present invention can not face malfunction of the off-grid master-slave solar inverter system because the control method provided by the present invention still can be utilized to determine which inverter is a new master inverter.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an off-grid master-slave solar inverter system according to an embodiment.

FIG. 2 is a diagram illustrating pulses corresponding to different numbers.

FIG. 3 is a diagram illustrating the first inverter first outputting a pulse corresponding to the first series number in the operation clock.

FIG. 4 is a diagram illustrating the first inverter outputting a pulse corresponding to the first series number and the second inverter outputting a pulse corresponding to the second series number simultaneously in the operation clock.

FIG. 5 is a flowchart illustrating a control method of an off-grid master-slave solar inverter system according to another embodiment.

### DETAILED DESCRIPTION

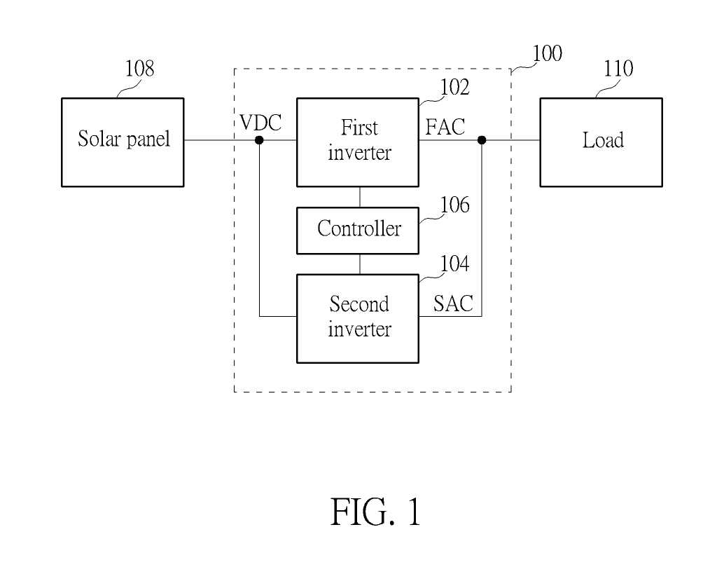

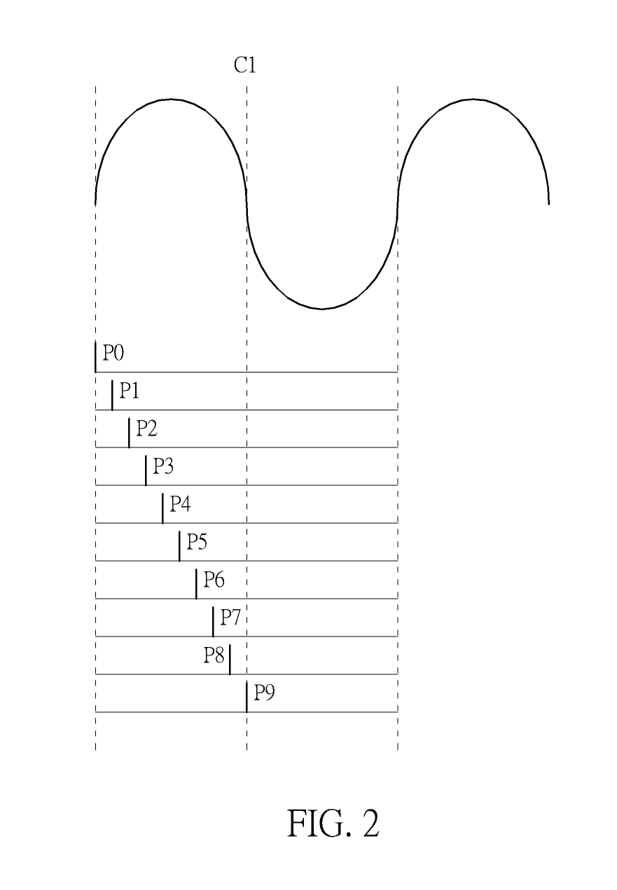

Please refer to FIG. 1. FIG. 1 is a diagram illustrating an off-grid master-slave solar inverter system 100 according to an embodiment. The off-grid master-slave solar inverter system 100 includes a first inverter 102, a second inverter 104, and a controller 106. The first inverter 102 has a first input terminal for coupling to a solar panel 108, and a first output terminal for coupling to a load 110, where the first inverter 102 is used for outputting pulses corresponding to a first series number and converting a DC voltage VDC generated by the solar panel 108 into a first AC voltage FAC. The second inverter 104 has a second input terminal for coupling to the solar panel 108, and a second output terminal for coupling to the load 110, where the second inverter 104 is used for outputting pulses corresponding to a second series number and converting the DC voltage VDC generated by the solar panel 108 into a second AC voltage SAC. The controller 106 is coupled to the first inverter 102 and the second inverter 104 for controlling the first inverter 102 and the second inverter 104 to output the pulses corresponding to the first series number and the pulses corresponding to the second series number, respectively, and controlling the first inverter 102 and the second inverter 104 to output the first AC voltage FAC and the second AC voltage SAC, respectively. Please refer to FIG. 2. FIG. 2 is a diagram illustrating pulses corresponding to different numbers. As shown in FIG. 2, in an operation clock C1 of the controller 106, a pulse P1 corresponding to “1”lags a pulse P0 corresponding to “0”, and a pulse P2 corresponding to “2” lags a pulse P1 corresponding to “1”. In addition, operational principles of pulses P3-P9 corresponding to other numbers are the same as the above mentioned principle, so further description thereof is omitted for simplicity. Therefore, in the operation clock C1 of the controller 106, a location of the pulse P9 corresponding to the operation clock C1 lags a location of the pulse P0 corresponding to the operation clock C1.

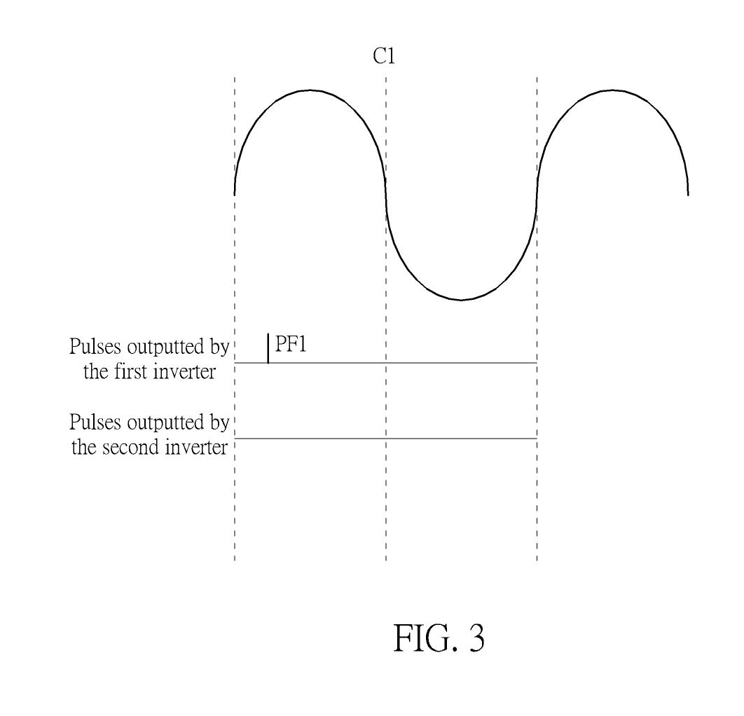

When the off-grid master-slave solar inverter system 100 is powered on, the controller 106 controls the first inverter 102 and the second inverter 104 to prepare to output the pulses corresponding to the first series number and the pulses corresponding to the second series number, respectively. Please refer to FIG. 3. FIG. 3 is a diagram illustrating the first inverter 102 first outputting a pulse PF1 corresponding to the first series number in the operation clock C1. As shown in FIG. 3, in the operation clock C1, because the first inverter 102 first outputs the pulse PF1 corresponding to the first series number (that is, first number of the first series number is less than first number of the second series number, so the first inverter 102 can first output the pulse PF1 corresponding to the first series number, and the controller 106 controls the second inverter 104 to stop outputting the pulses corresponding to the second series number), the controller 106 can determine that the first inverter 102 is a master inverter and the second inverter 104 is a slave inverter. Then, after the controller 106 determines that the first inverter 102 is the master inverter for a first predetermined time, the controller 106 can control the first inverter 102 to output the first AC voltage FAC, and the second inverter 104 to output the second AC voltage SAC with a frequency of the first AC voltage FAC, where the first predetermined time is equal to three periods of the frequency of the first AC voltage FAC. But, the present invention is not limited to the first predetermined time being equal to three periods of the frequency of the first AC voltage FAC. In addition, operational principles of the second inverter 104 first outputting the pulses corresponding to the second series number are the same as those of the first inverter 102 first outputting the pulses corresponding to the first series number, so further description thereof is omitted for simplicity.

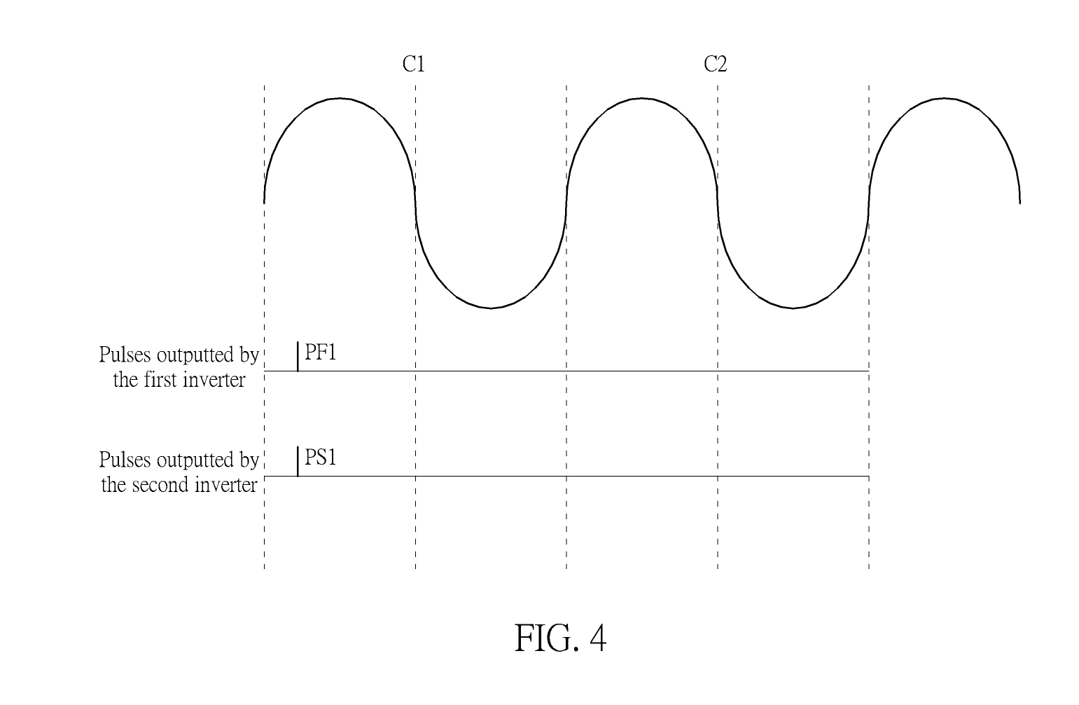

Please refer to FIG. 4. FIG. 4 is a diagram illustrating the first inverter 102 outputting a pulse PF1 corresponding to the first series number and the second inverter 104 outputting a pulse PS1 corresponding to the second series number simultaneously in the operation clock C1. As shown in FIG. 4, in the operation clock C1, because the first inverter 102 outputs the pulse PF1 corresponding to the first series number and the second inverter 104 outputs the pulse PS1 corresponding to the second series number simultaneously (that is, first number of the first series number is equal to first number of the second series number, so the first inverter 102 outputs the pulse PF1 corresponding to the first series number and the second inverter 104 outputs the pulse PS1 corresponding to the second series number simultaneously), the controller 106 can not determine which inverter is a master inverter. Then, the controller 106 can control the first inverter 102 and the second inverter 104 to prepare to output a pulse corresponding to the first series number (that is, corresponding to second number of the first series number) and a pulse corresponding to the second series number (that is, corresponding to second number of the second series number) in an operation clock C2. Thus, the controller 106 can repeat the above mentioned steps until the controller 106 can determine which inverter is a master inverter.

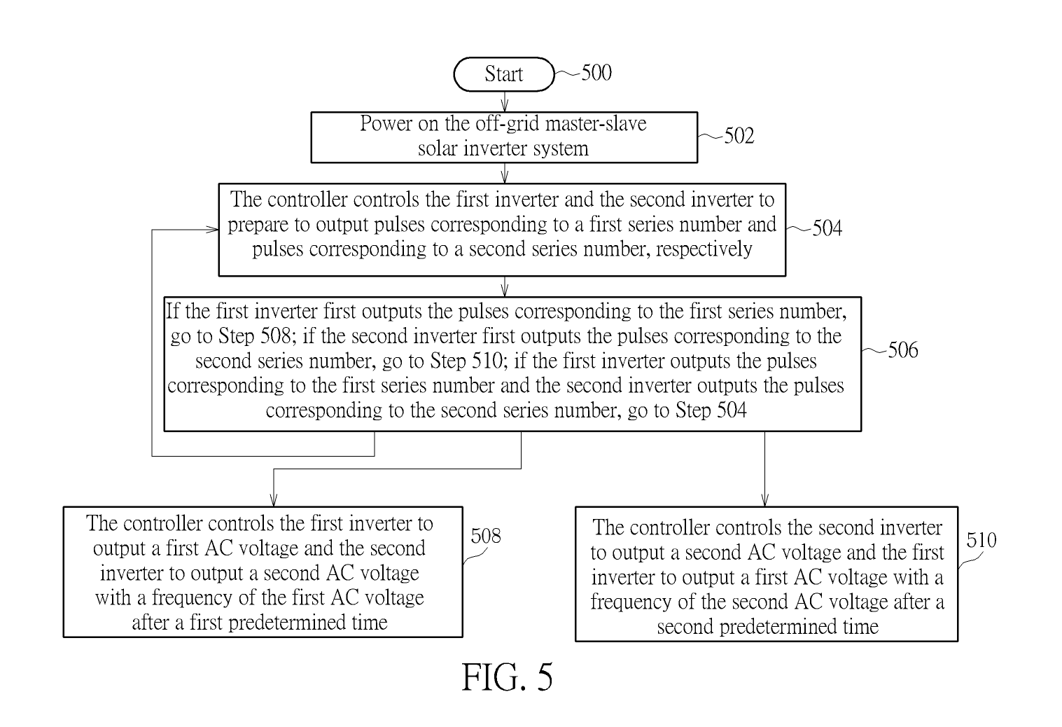

Please refer to FIG. 3, FIG. 4, and FIG. 5. FIG. 5 is a flowchart illustrating a control method of an off-grid master-slave solar inverter system according to another embodiment. The control method in FIG. 5 is illustrated using the off-grid master-slave solar inverter system 100 in FIG. 1. Detailed steps are as follows:

Step 500: Start.

Step 502: Power on the off-grid master-slave solar inverter system 100.

Step 504: The controller 106 controls the first inverter 102 and the second inverter 104 to prepare to output pulses corresponding to a first series number and pulses corresponding to a second series number, respectively.

Step 506: If the first inverter 102 first outputs the pulses corresponding to the first series number, go to Step 508; if the second inverter 104 first outputs the pulses corresponding to the second series number, go to Step 510; if the first inverter 102 outputs the pulses corresponding to the first series number and the second inverter 104 outputs the pulses corresponding to the second series number, go to Step 504.

Step 508: The controller 106 controls the first inverter 102 to output a first AC voltage FAC and the second inverter 104 to output a second AC voltage SAC with a frequency of the first AC voltage FAC after a first predetermined time.

Step 510: The controller 106 controls the second inverter 104 to output a second AC voltage SAC and the first inverter 102 to output a first AC voltage FAC with a frequency of the second AC voltage SAC after a second predetermined time.

In Step 506, as shown in FIG. 4, the controller 106 can not determine which inverter is a master inverter when the first inverter 102 outputs the pulse PF1 corresponding to the first series number and the second inverter 104 outputs the pulse PS1 corresponding to the second series number simultaneously in the operation clock C1. Therefore, the controller 106 can control the first inverter 102 and the second inverter 104 to prepare to output a pulse corresponding to the first series number (corresponding to second number of the first series number) and a pulse corresponding to the second series number (corresponding to second number of the second series number) in the operation clock C2. In Step 508, as shown in FIG. 3, in the operation clock C1, because the first inverter 102 first outputs the pulse PF1 corresponding to the first series number, the controller 106 can determine that the first inverter 102 is a master inverter and the second inverter 104 is a slave inverter. Then, after the controller 106 determines that the first inverter 102 is the master inverter for a first predetermined time, the controller 106 can control the first inverter 102 to output the first AC voltage FAC, and the second inverter 104 to output the second AC voltage SAC with the frequency of the first AC voltage FAC, where the first predetermined time is equal to three periods of the frequency of the first AC voltage. But, the present invention is not limited to the first predetermined time being three periods of the frequency of the first AC voltage. In addition, in Step 510, operational principles of the second inverter 104 first outputting the pulses corresponding to the second series number are the same as those of the first inverter 102 first outputting the pulses corresponding to the first series number, so further description thereof is omitted for simplicity.

To sum up, the off-grid master-slave solar inverter system and the control method thereof utilize the controller to control the first inverter and the second inverter to output pulses corresponding to the first series number and pulses corresponding to the second series number, respectively. Then, the controller can determine which inverter is a master inverter by a condition of the first inverter and the second inverter outputting the pulses corresponding to the first series number and the pulses corresponding to the second series number, respectively. Therefore, compared to the prior art, the control method provided by the present invention is simpler. In addition, when the master inverter fails, the present invention can not face malfunction of the off-grid master-slave solar inverter system because the control method provided by the present invention still can be utilized to determine which inverter is a new master inverter.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of an off-grid master-slave solar inverter system, the off-grid master-slave solar inverter system comprising a first inverter, a second inverter, and a controller, the control method comprising:
powering on the off-grid master-slave solar inverter system;
the controller controlling the first inverter and the second inverter to prepare to output pulses corresponding to a first series number and pulses corresponding to a second series number, respectively;
only the first inverter outputting a pulse corresponding to a first number of the first series number; and
the controller controlling the first inverter to output a first alternating current (AC) voltage and the second inverter to output a second AC voltage with a frequency of the first AC voltage after a first predetermined time.

2. The control method of claim 1, wherein the first predetermined time is equal to three periods of the frequency of the first AC voltage.

3. The control method of claim 1, wherein the first inverter converts a direct current (DC) voltage of a solar panel into the first AC voltage, and the second AC voltage converts the DC voltage into the second AC voltage.

4. The control method of claim 1, further comprising:
the first inverter outputting a pulse corresponding to a second number of the first series number and the second inverter outputting a pulse corresponding to a second number of the second series number simultaneously; and
the controller controlling the first inverter and the second inverter to prepare to again output the pulses corresponding to the first series number and the pulses corresponding to the second series number, respectively.

5. An off-grid master-slave solar inverter system, comprising:
a first inverter having a first input terminal for coupling to a solar panel, and a first output terminal for coupling to a load, wherein the first inverter is used for outputting pulses corresponding to a first series number and converting a DC voltage of the solar panel into a first AC voltage;
a second inverter having a second input terminal for coupling to the solar panel, and a second output terminal for coupling to the load, wherein the second inverter is used for outputting pulses corresponding to a second series number and converting the DC voltage of the solar panel into a second AC voltage; and
a controller coupled to the first inverter and the second inverter for controlling the first inverter and the second inverter to output the pulses corresponding to the first series number and the pulses corresponding to the second series number, respectively, and controlling the first inverter and the second inverter to output the first AC voltage and the second AC voltage, respectively.

6. The off-grid master-slave solar inverter system of claim 5, wherein the controller controls the first inverter to output the first AC voltage and the second inverter to output the second AC voltage with a frequency of the first AC voltage after a first predetermined time when only the first inverter outputs the pulses corresponding to the first series number.

7. The off-grid master-slave solar inverter system of claim 5, wherein the first predetermined time is equal to three periods of the frequency of the first AC voltage.

8. The off-grid master-slave solar inverter system of claim 5, wherein when the first inverter outputs a pulse corresponding to a second number of the first series number and the second inverter outputs a pulse corresponding to a second number of the second series number simultaneously, the controller controls the first inverter and the second inverter to prepare to again output corresponding to the pulses corresponding to the first series number and the pulses corresponding to the second series number, respectively.
